(19) United States
(12) Patent Application Publication
(10) Pub. No.: US 2019/0064616 A1
(43) Pub. Date: Feb. 28, 2019

(54) TRANSFLECTIVE LIQUID CRYSTAL DISPLAY

(71) Applicant: Shenzhen China Star Optoelectronics Semiconductor Display Technology Co., Ltd., Shenzhen City (CN)

(72) Inventors: Minggang Liu, Shenzhen City (CN); Yunglun Lin, Shenzhen City (CN)

(21) Appl. No.: 15/578,246

(22) PCT Filed: Nov. 15, 2017
(86) PCT No.: PCT/CN2017/111027

§ 371 Date: Nov. 30, 2017

(30) Foreign Application Priority Data
Aug. 25, 2017 (CN) 201710745224.9

(51) Int. Cl. G02F 1/1362; G02F 1/1368; G02F 1/1339; G02F 1/1343; G02F 1/1335

(52) U.S. Cl. CPC G02F 1/136209; G02F 1/1368; G02F 1/13394; G02F 1/13439; G02F 1/133553; G02F 2203/09; G02F 2001/136222; G02F 2201/123; G02F 2001/133531; G02F 2201/121; G02F 1/133528

(57) ABSTRACT

The present invention provides a transflective liquid crystal display, which adopts an arrangement involving COA and BPS and provides a reflective electrode on a black matrix of a BPS light-shielding layer and makes the reflective electrode connected to a pixel electrode so as to form a reflective zone in an area of a device that corresponds to the reflective electrode and also to form a transmissive zone in an area corresponding to the pixel electrode thereby increasing brightness of a displayed image when the external light is intense. In addition, the reflective zone does not occupy an area of the transmissive zone and thus does not affect the transmission rate of the device. Further, liquid crystal cell thicknesses in the reflective zone and the transmissive zone are controllable through controlling the thickness of the black matrix without the necessity of adding an extra insulation layer so that the structure is made simple.

### BACKGROUND OF THE INVENTION

### 1. Field of the Invention

The present invention relates to the field of liquid crystal display technology, and more particular to a transflective liquid crystal display.

### 2. The Related Arts

With the progress of the display technology, flat panel display devices, such as liquid crystal displays (LCDs), due to various advantages, such as high image quality, low power consumption, thin device body, and wide range of applications, have been widely used in all sorts of consumer electronic products, including mobile phones, televisions, personal digital assistants (PDAs), digital cameras, notebook computers, and desktop computers so as to take a leading position in the field of flat panel display devices.

According to lighting requirement, the LCDs that are currently available in the market can be roughly divided into three categories, including transmissive liquid crystal displays, reflective liquid crystal displays, and transflective liquid crystal displays. The transmissive liquid crystal displays includes a backlight module arranged on the back side of a liquid crystal panel to serve as a light source, wherein light emitting from the backlight module transmits through a transparent pixel electrode of an array substrate to display an image. The transmissive liquid crystal displays are fit to environments of weak light sources, such as being used indoors. However, for outdoor use, since the external lighting is excessively strong, the magnitude of the backlighting is affected by the external light so that eyes, when viewing the display, cannot perceives clear images due to excessive brightness of the panel and this affects the image quality. In addition, long term uses of the backlight source would consume a large amount of electrical power. Display devices of small sizes are generally powered by electrical batteries and a situation of running out of power may readily occur.

The reflective liquid crystal displays use front lighting or external natural lighting as a light source and involve an array substrate that is provided with a reflective electrode that is made of a metal or other materials that show excellent reflectivity so that the front lighting or external natural lighting can be reflected by the reflective electrode to realize image displaying. The reflective liquid crystal displays are suitable for use in sites where the external light source is strong so that image displaying can be realized through reflection of natural light and power consumption of the displays can be reduced. However, in sites where light source is weak, a situation of insufficient light intensity may occur, and this affects the image quality.

The transflective liquid crystal display panels are a combination of the transmissive and reflective liquid crystal display panels, and comprise an array substrate in which a reflective zone and a transmissive zone are both provided so that displaying can be achieved by using both the backlighting and front lighting or external lighting. In an environment where the lighting is dark, the liquid crystal display panel displays an image by primarily using the transmissive mode, meaning using lighting from the backlight source of the liquid crystal display itself, and in a situation where light, such as sunlight, is sufficient, the reflective mode is used, where the reflective electrode provided in the liquid crystal display panel reflects the external natural light to serve as a light source for image displaying. Thus, the transflective liquid crystal displays are applicable to external environments of various lighting intensity and particularly showing the characteristics of outdoor visibility and requiring no high brightness level of the backlighting thereby featuring low power consumption.

Referring to FIG. 1, which is a schematic view showing a structure of a conventional transflective liquid crystal display device, the transflective liquid crystal display device comprises an upper substrate 100′ and a lower substrate 200′ that are arranged opposite to each other and a liquid crystal layer 300′ arranged between the upper substrate 100′ and the lower substrate 200′, wherein the upper substrate 100′ is a color filter substrate that includes a common electrode 110′, and the lower substrate 200′ comprises an array substrate 210′, an insulation layer 220′ arranged on the array substrate 210′, and a reflective electrode 230′ arranged on the insulation layer 220′. The lower substrate 200′ comprises a reflective zone 201′ and a transmissive zone 202′. The insulation layer 220′ and the reflective electrode 230′ both correspond to the reflective zone 201′. The array substrate 210′ is provided, in the transmissive zone 202′, with a pixel electrode 211′. A portion of the liquid crystal layer 300′ that corresponds to the reflective zone 201′ has a thickness that is one half of that of a portion that corresponds to the transmissive zone 202′. The transflective liquid crystal display device, although capable of transmissive-reflective displaying, suffers the existence of the reflective zone 201′ that severely affects the transmission rate of the liquid crystal display device, and requires control of the thickness of the insulation layer 220′ such that the thickness of the liquid crystal layer 300′ in the reflective zone 201′ is one half of the thickness thereof in the transmissive zone 202′, the manufacturing process being complicated and hard to achieve.

### SUMMARY OF THE INVENTION

An objective of the present invention is to provide a transflective liquid crystal display, which increases brightness of a displayed image when the intensity of external lighting is high, and shows a high transmission rate, requires no additional insulation layer, and has a simple structure.

To achieve the above objective, the present invention provides a transflective liquid crystal display, which comprises: an upper substrate and a lower substrate that are arranged opposite to each other and a liquid crystal layer arranged between the upper substrate and the lower substrate;

wherein the lower substrate comprises a first backing, a thin-film transistor (TFT) array layer arranged on the first backing, a color resist layer arranged on the TFT array layer, a planarization layer covering the color resist layer and the TFT array layer, a black-photo-spacer (BPS) light-shielding layer arranged on the planarization layer, a pixel electrode arranged on the planarization layer, and a reflective electrode arranged on the BPS light-shielding layer;

the BPS light-shielding layer comprises a black matrix and a main photo spacer and a sub photo spacer arranged on the black matrix and spaced from each other; the reflective electrode is arranged on the black matrix and the reflective electrode and the pixel electrode are connected;

the reflective electrode and the upper substrate are spaced from each other by a distance that is one half of a distance between the pixel electrode and the upper substrate.

The lower substrate comprises a plurality of sub-pixels that are arranged in an array; the color resist layer comprises a plurality of color resist blocks arranged to respectively correspond to the plurality of sub-pixels and two adjacent rows of the color resist blocks are spaced from each other; the color resist layer further comprises a plurality of color resist bridges arranged between two adjacent rows of the color resist blocks; and

the black matrix of the BPS light-shielding layer covers an area between two adjacent rows of the color resist blocks and the main photo spacer is located above and corresponds to the color resist bridges.

The BPS light-shielding layer is formed by subjecting a BPS material layer formed on the planarization layer to a photolithographic process with a multi-tone mask.

The multi-tone mask comprises a portion that is used to form the main photo spacer and has a light transmission rate that is identical to a light transmission rate of a portion thereof that is used to form the sub photo spacer.

The transflective liquid crystal display further comprises an upper polarizer plate arranged on one side of the upper substrate that is distant from the lower substrate and a lower polarizer plate arranged on one side of the lower substrate that is distant from the upper substrate.

The upper polarizer plate has an optical axis that is parallel to an axis of the lower polarizer plate.

The transflective liquid crystal display further comprises a backlight module arranged on one side of the lower polarizer plate that is distant from the lower substrate.

The upper substrate comprises a second backing and a common electrode arranged on one side of the second backing that is adjacent to the lower substrate.

The reflective electrode is formed of a material comprising aluminum or silver.

The present invention also provides a transflective liquid crystal display, which comprises: an upper substrate and a lower substrate that are arranged opposite to each other and a liquid crystal layer arranged between the upper substrate and the lower substrate;

wherein the lower substrate comprises a first backing, a thin-film transistor (TFT) array layer arranged on the first backing, a color resist layer arranged on the TFT array layer, a planarization layer covering the color resist layer and the TFT array layer, a black-photo-spacer (BPS) light-shielding layer arranged on the planarization layer, a pixel electrode arranged on the planarization layer, and a reflective electrode arranged on the BPS light-shielding layer;

the BPS light-shielding layer comprises a black matrix and a main photo spacer and a sub photo spacer arranged on the black matrix and spaced from each other; the reflective electrode is arranged on the black matrix and the reflective electrode and the pixel electrode are connected;

the reflective electrode and the upper substrate are spaced from each other by a distance that is one half of a distance between the pixel electrode and the upper substrate;

wherein the lower substrate comprises a plurality of sub-pixels that are arranged in an array; the color resist layer comprises a plurality of color resist blocks arranged to respectively correspond to the plurality of sub-pixels and two adjacent rows of the color resist blocks are spaced from each other; the color resist layer further comprises a plurality of color resist bridges arranged between two adjacent rows of the color resist blocks; and

the black matrix of the BPS light-shielding layer covers an area between two adjacent rows of the color resist blocks and the main photo spacer is located above and corresponds to the color resist bridges;

wherein the BPS light-shielding layer is formed by subjecting a BPS material layer formed on the planarization layer to a photolithographic process with a multi-tone mask;

wherein the multi-tone mask comprises a portion that is used to form the main photo spacer and has a light transmission rate that is identical to a light transmission rate of a portion thereof that is used to form the sub photo spacer; and

further comprising an upper polarizer plate arranged on one side of the upper substrate that is distant from the lower substrate and a lower polarizer plate arranged on one side of the lower substrate that is distant from the upper substrate.

The efficacy of the present invention is that the present invention provides a transflective liquid crystal display, which adopts an arrangement involving COA and BPS and provides a reflective electrode on a black matrix of a BPS light-shielding layer and makes the reflective electrode connected to a pixel electrode so as to form a reflective zone in an area of a device that corresponds to the reflective electrode and also to form a transmissive zone in an area corresponding to the pixel electrode thereby increasing brightness of a displayed image when the external light is intense. In addition, the reflective zone does not occupy an area of the transmissive zone and thus does not affect the transmission rate of the device. Further, liquid crystal cell thicknesses in the reflective zone and the transmissive zone are controllable through controlling the thickness of the black matrix without the necessity of adding an extra insulation layer so that the structure is made simple.

### BRIEF DESCRIPTION OF THE DRAWINGS

For better understanding of the features and technical contents of the present invention, reference will be made to the following detailed description of the present invention and the attached drawings. However, the drawings are provided only for reference and illustration and are not intended to limit the present invention.

In the drawings:

FIG. 1 is a schematic view illustrating a cross-sectional structure of a conventional transflective liquid crystal display;

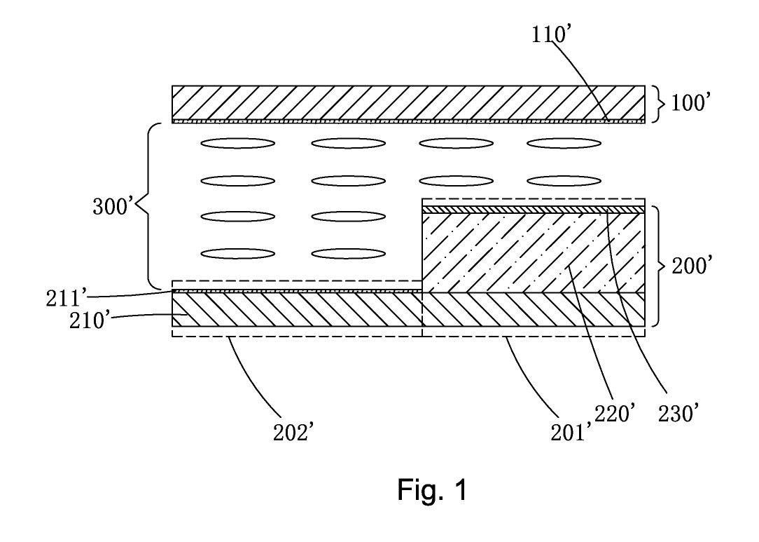

FIG. 2 is a schematic view illustrating a cross-sectional structure of a transflective liquid crystal display according to the present invention taken at a site of a main photo spacer;

FIG. 3 is a schematic view illustrating a cross-sectional structure of the transflective liquid crystal display according to the present invention taken at a site of a black matrix;

FIG. 4 is a top plan view illustrating a color resist layer of the transflective liquid crystal display according to the present invention; and

FIG. 5 is a top plan view illustrating a color resist layer and a black-photo-spacer (BPS) light-shielding layer of the transflective liquid crystal display according to the present invention.

### DETAILED DESCRIPTION OF THE PREFERRED EMBODIMENTS

To further expound the technical solution adopted in the present invention and the advantages thereof, a detailed description will be given with reference to the preferred embodiments of the present invention and the drawings thereof.

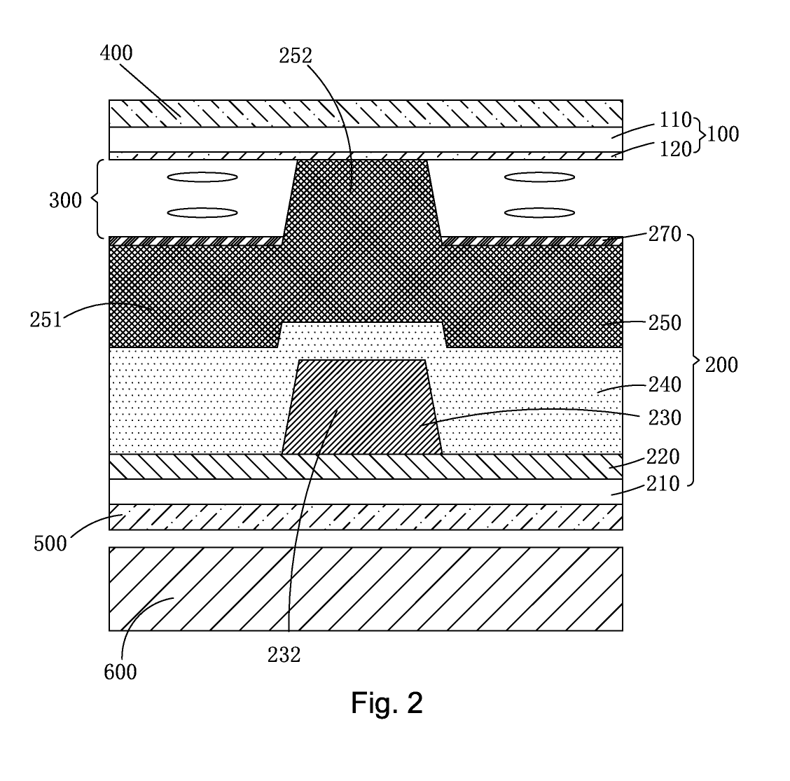

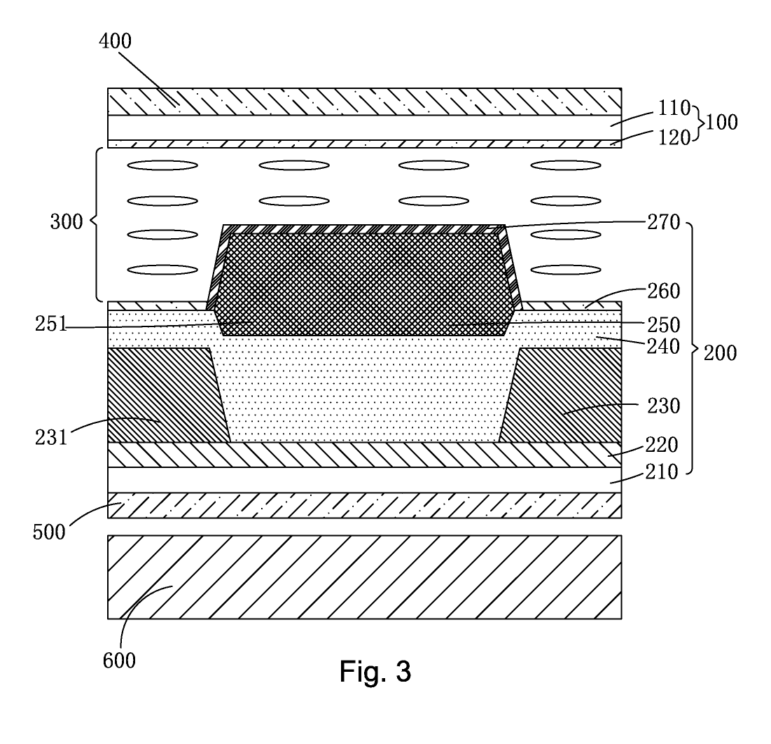

The present invention provides a transflective liquid crystal display, which involves the application of a technique that allows a color filter layer to be directly formed on an array substrate (namely Color Filter on Array, COA) and a technique that allows a black matrix and main and sub photo spacers to be formed of a black-photo-spacer (BPS) material with the same manufacturing process. Referring to FIGS. 2-5, the transflective liquid crystal display according to the present invention comprises: an upper substrate 100 and a lower substrate 200 that are arranged opposite to each other, a liquid crystal layer 300 arranged between the upper substrate 100 and the lower substrate 200, an upper polarizer plate 400 arranged on one side of the upper substrate 100 that is distant from the lower substrate 200, a lower polarizer plate 500 arranged on one side of the lower substrate 200 that is distant from the upper substrate 100, and a backlight module 600 arranged on one side of the lower polarizer plate 500 that is distant from the lower substrate 200.

The lower substrate 200 comprises a first backing 210, a thin-film transistor (TFT) array layer 220 arranged on the first backing 210, a color resist layer 230 arranged on the TFT array layer 220, a planarization layer 240 covering the color resist layer 230 and the TFT array layer 220, a BPS light-shielding layer 250 arranged on the planarization layer 240, a pixel electrode 260 arranged on the planarization layer 240, and a reflective electrode 270 arranged on the BPS light-shielding layer 250. The BPS light-shielding layer 250 comprises a black matrix 251 and a main photo spacer 252 and a sub photo spacer 253 arranged on the black matrix 251 and spaced from each other. The reflective electrode 270 is arranged on the black matrix 251 and the reflective electrode 270 and the pixel electrode 260 are connected. The reflective electrode 270 and the upper substrate 100 are spaced from each other by a distance that is one half of a distance between the pixel electrode 260 and the upper substrate 100.

Specifically, the upper polarizer plate 400 has an optical axis that is parallel to an axis of the lower polarizer plate 500. In other words, without application of an electrical voltage, the transflective liquid crystal display of the present invention is in a normally black state.

Specifically, the upper substrate 100 comprises a second backing 110 and a common electrode 120 arranged on one side of the second backing 110 that is adjacent to the lower substrate 200.

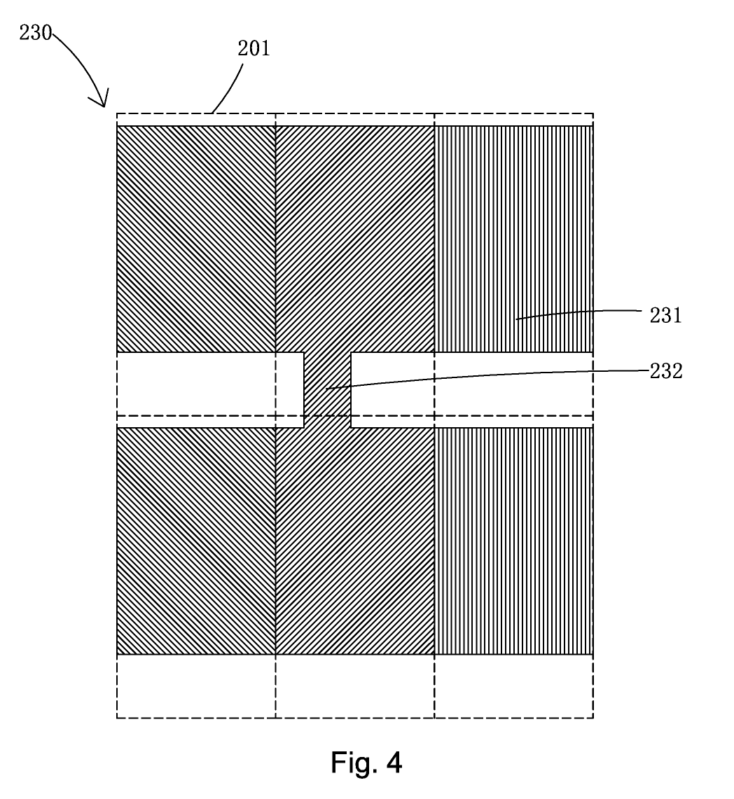

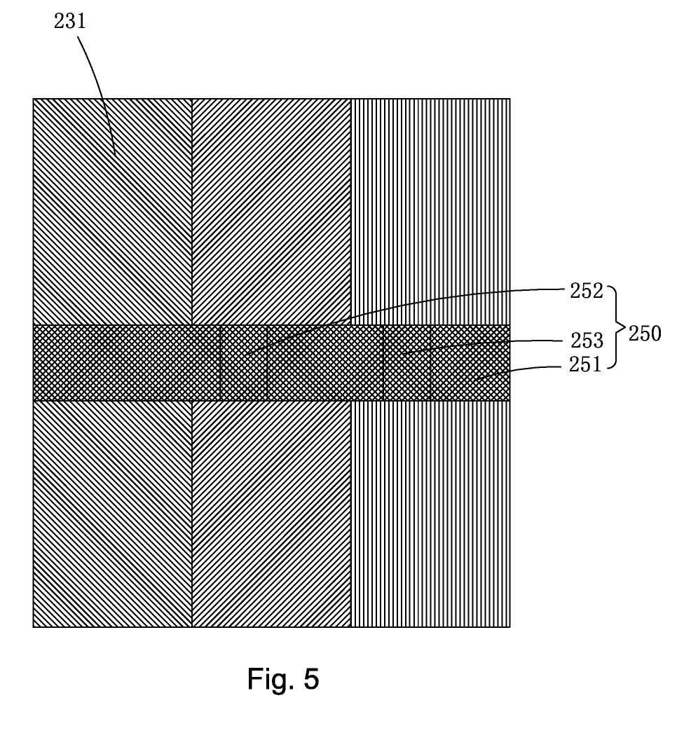

Specifically, referring to FIG. 4, in this invention, the lower substrate 200 comprises a plurality of sub-pixels 201 that are arranged in an array. The color resist layer 230 comprises a plurality of color resist blocks 231 arranged to respectively correspond to the plurality of sub-pixels 201 and two adjacent rows of the color resist blocks 231 are spaced from each other. The color resist layer 230 further comprises a plurality of color resist bridges 232 arranged between two adjacent rows of the color resist blocks 231. Referring to FIG. 5, the black matrix 251 of the BPS light-shielding layer 250 covers an area between two adjacent rows of the color resist blocks 231 and the main photo spacer 252 is located above and corresponds to the color resist bridges 232.

Specifically, the BPS light-shielding layer 250 is formed by subjecting a BPS material layer formed on the planarization layer 240 to a photolithographic process with a multi-tone mask. Specifically, the multi-tone mask comprises a portion that is used to form the main photo spacer 252 and has a light transmission rate that is identical to a light transmission rate of a portion thereof that is used to form the sub photo spacer 253.

Further, for a BPS material layer that comprises a negative photoresist material, the multi-tone mask comprises a full light transmitting zone for forming the main photo spacer 252 and the sub photo spacer 253, a partial light transmitting zone for forming the black matrix 251, and a light non-transmitting zone located other than the full light transmitting zone and the partial light transmitting zone; and for a BPS material layer that comprises a positive photoresist material, the multi-tone mask comprises a light non-transmitting zone for forming the main photo spacer 252 and the sub photo spacer 253, a partial light transmitting zone for forming the black matrix 251, and a full light transmitting zone located other than the light non-transmitting zone and the partial light transmitting zone, so that the multi-tone mask can be used to subject the BPS material layer formed on the planarization layer 240 to exposure, followed by development, to form a BPS light-shielding layer 250 that comprises a black matrix 251 and a main photo spacer 252 and a sub photo spacer 253 that are arranged on the black matrix 251 and are spaced from each other. Also, due to the arrangement of the color resist bridges 232, even the portion of the multi-tone mask that is used to form the main photo spacer 252 and the portion that is used to form the sub photo spacer 253 have the same light transmission rate, it still possible to form a height difference between the main photo spacer 252 and the sub photo spacer 253 to achieve the functionality of the main and sub photo spacers 252, 253.

Specifically, the reflective electrode 270 is formed of a material comprising aluminum (Al), silver (Ag), or other conductive materials having high reflectivity.

It is noted that the transflective liquid crystal display of the present invention adopts a BPS arrangement and also provides the reflective electrode 270 on the black matrix 251 of the BPS light-shielding layer 250 and also makes the reflective electrode 270 connected to the pixel electrode 260 so as to form a reflective zone in an area corresponding to the reflective electrode 270 and also form a transmissive zone in an area corresponding to the pixel electrode 260 with a distance between the pixel electrode 260 and the upper substrate 100 being twice of a distance between the reflective electrode 270 and the upper substrate 100 to make optical path difference equal for both the transmissive zone and the reflective zone. Under a condition of no application of electrical voltage, the transmissive zone is in a dark state. Since the optical path difference of the reflective zone is the same as that of the transmissive zone, the reflective zone is also in a dark state. When an electrical voltage is applied between the common electrode 120 and the pixel electrode 260 to make the transmissive zone a bright state, since the pixel electrode 260 and the reflective electrode 270 are connected, portions of liquid crystal in the transmissive zone and the reflective zone are of synchronous rotation so that the reflective zone is also in a bright state thereby increasing displaying brightness of an image. Further, the more intense the external light is, the higher the brightness of the reflective zone will be and the higher the displaying brightness of an image. Further, by controlling operation parameters for the formation of the BPS light-shielding layer 250, it can readily control a height difference between the black matrix 251 and the planarization layer 240 and a height difference between the black matrix 251 and the main photo spacer 252 so that a distance between the pixel electrode 260 that is formed on the planarization layer 240 and the upper substrate 100 is double of a distance between the reflective electrode 270 that is formed on the black matrix 251 and the upper substrate 100, and this, as compared to the known techniques, requires no additional insulation layer to be included, has a simple structure, and involves a manufacturing process that has a low level of difficulty, and in addition, the reflective zone is arranged on the black matrix 251 without occupying an area of the transmissive zone so as not to affect the transmission rate of a device.

In summary, the present invention provides a transflective liquid crystal display, which adopts an arrangement involving COA and BPS and provides a reflective electrode on a black matrix of a BPS light-shielding layer and makes the reflective electrode connected to a pixel electrode so as to form a reflective zone in an area of a device that corresponds to the reflective electrode and also to form a transmissive zone in an area corresponding to the pixel electrode thereby increasing brightness of a displayed image when the external light is intense. In addition, the reflective zone does not occupy an area of the transmissive zone and thus does not affect the transmission rate of the device. Further, liquid crystal cell thicknesses in the reflective zone and the transmissive zone are controllable through controlling the thickness of the black matrix without the necessity of adding an extra insulation layer so that the structure is made simple.

Based on the description given above, those having ordinary skills in the art may easily contemplate various changes and modifications of he technical solution and the technical ideas of the present invention. All these changes and modifications are considered belonging to the protection scope of the present invention as defined in the appended claims.

What is claimed is:

1. A transflective liquid crystal display, comprising: an upper substrate and a lower substrate that are arranged opposite to each other and a liquid crystal layer arranged between the upper substrate and the lower substrate;
wherein the lower substrate comprises a first backing, a thin-film transistor (TFT) array layer arranged on the first backing, a color resist layer arranged on the TFT array layer, a planarization layer covering the color resist layer and the TFT array layer, a black-photo-spacer (BPS) light-shielding layer arranged on the planarization layer, a pixel electrode arranged on the planarization layer, and a reflective electrode arranged on the BPS light-shielding layer;
the BPS light-shielding layer comprises a black matrix and a main photo spacer and a sub photo spacer arranged on the black matrix and spaced from each other; the reflective electrode is arranged on the black matrix and the reflective electrode and the pixel electrode are connected; and
the reflective electrode and the upper substrate are spaced from each other by a distance that is one half of a distance between the pixel electrode and the upper substrate.

2. The transflective liquid crystal display as claimed in claim 1, wherein the lower substrate comprises a plurality of sub-pixels that are arranged in an array; the color resist layer comprises a plurality of color resist blocks arranged to respectively correspond to the plurality of sub-pixels and two adjacent rows of the color resist blocks are spaced from each other; the color resist layer further comprises a plurality of color resist bridges arranged between two adjacent rows of the color resist blocks; and
the black matrix of the BPS light-shielding layer covers an area between two adjacent rows of the color resist blocks and the main photo spacer is located above and corresponds to the color resist bridges.

3. The transflective liquid crystal display as claimed in claim 2, wherein the BPS light-shielding layer is formed by subjecting a BPS material layer formed on the planarization layer to a photolithographic process with a multi-tone mask.

4. The transflective liquid crystal display as claimed in claim 3, wherein the multi-tone mask comprises a portion that is used to form the main photo spacer and has a light transmission rate that is identical to a light transmission rate of a portion thereof that is used to form the sub photo spacer.

5. The transflective liquid crystal display as claimed in claim 1 further comprising an upper polarizer plate arranged on one side of the upper substrate that is distant from the lower substrate and a lower polarizer plate arranged on one side of the lower substrate that is distant from the upper substrate.

6. The transflective liquid crystal display as claimed in claim 5, wherein the upper polarizer plate has an optical axis that is parallel to an axis of the lower polarizer plate.

7. The transflective liquid crystal display as claimed in claim 5 further comprising a backlight module arranged on one side of the lower polarizer plate that is distant from the lower substrate.

8. The transflective liquid crystal display as claimed in claim 1, wherein the upper substrate comprises a second backing and a common electrode arranged on one side of the second backing that is adjacent to the lower substrate.

9. The transflective liquid crystal display as claimed in claim 1, wherein the reflective electrode is formed of a material comprising aluminum or silver.

10. A transflective liquid crystal display, comprising: an upper substrate and a lower substrate that are arranged opposite to each other and a liquid crystal layer arranged between the upper substrate and the lower substrate;
wherein the lower substrate comprises a first backing, a thin-film transistor (TFT) array layer arranged on the first backing, a color resist layer arranged on the TFT array layer, a planarization layer covering the color resist layer and the TFT array layer, a black-photo-spacer (BPS) light-shielding layer arranged on the planarization layer, a pixel electrode arranged on the planarization layer, and a reflective electrode arranged on the BPS light-shielding layer;
the BPS light-shielding layer comprises a black matrix and a main photo spacer and a sub photo spacer arranged on the black matrix and spaced from each other; the reflective electrode is arranged on the black matrix and the reflective electrode and the pixel electrode are connected;
the reflective electrode and the upper substrate are spaced from each other by a distance that is one half of a distance between the pixel electrode and the upper substrate;
wherein the lower substrate comprises a plurality of sub-pixels that are arranged in an array; the color resist layer comprises a plurality of color resist blocks arranged to respectively correspond to the plurality of sub-pixels and two adjacent rows of the color resist blocks are spaced from each other; the color resist layer further comprises a plurality of color resist bridges arranged between two adjacent rows of the color resist blocks; and
the black matrix of the BPS light-shielding layer covers an area between two adjacent rows of the color resist blocks and the main photo spacer is located above and corresponds to the color resist bridges;
wherein the BPS light-shielding layer is formed by subjecting a BPS material layer formed on the planarization layer to a photolithographic process with a multi-tone mask;
wherein the multi-tone mask comprises a portion that is used to form the main photo spacer and has a light transmission rate that is identical to a light transmission rate of a portion thereof that is used to form the sub photo spacer; and
further comprising an upper polarizer plate arranged on one side of the upper substrate that is distant from the lower substrate and a lower polarizer plate arranged on one side of the lower substrate that is distant from the upper substrate.

11. The transflective liquid crystal display as claimed in claim 10, wherein the upper polarizer plate has an optical axis that is parallel to an axis of the lower polarizer plate.

12. The transflective liquid crystal display as claimed in claim 10 further comprising a backlight module arranged on one side of the lower polarizer plate that is distant from the lower substrate.

13. The transflective liquid crystal display as claimed in claim 10, wherein the upper substrate comprises a second backing and a common electrode arranged on one side of the second backing that is adjacent to the lower substrate.

14. The transflective liquid crystal display as claimed in claim 10, wherein the reflective electrode is formed of a material comprising aluminum or silver.
